(19) United States
(12) Patent Application Publication
(10) Pub. No.: US 2017/0213162 A1
(43) Pub. Date: Jul. 27, 2017

(54) SYSTEM AND METHOD FOR PROVIDING A REAL TIME VIRTUAL TRAVEL SERVICE

(71) Applicant: Evgenii Vadimovich Savostianov, Moscow (RU)

(72) Inventor: Evgenii Vadimovich Savostianov, Moscow (RU)

(21) Appl. No.: 15/348,282

(22) Filed: Nov. 10, 2016

Related U.S. Application Data
(60) Provisional application No. 62/286,158, filed on Jan. 22, 2016.

(51) Int. Cl. G06Q 10/02; G06F 17/28; G06Q 30/04

(52) U.S. Cl. CPC G06Q 10/02; G06Q 30/04; G06F 17/289

(57) ABSTRACT

A method and system to provide an on-demand real-time virtual travel service to a traveler utilizing a virtual travel management system. The virtual travel management system provides virtual travel demonstration of geographical locations to the traveler without having to be physically present at those destinations. A proxy is equipped with a proxy communication device and a portable audio-video monitoring and transmitting device. The traveler is equipped with a traveler communication device and a multimedia receiving device. The proxy communication device and the traveler communication device are installed with a virtual travel management software application. The audio-video monitoring and transmitting device transmits a real-time demonstration of picture and sound from a proxy location to the multimedia receiving device in response to the traveler's virtual travel service real-time commands. The multimedia receiving device receives and displays the real time demonstration of picture and sound to the traveler. The method and system allows a traveler to transmit real-time commands to at least one proxy to make the proxy to respond with real-time demonstration of picture and sound in response to the traveler's real-time commands.

### CROSS-REFERENCE TO RELATED APPLICATIONS

This application claims the benefit of the U.S. Provisional Application 62/286,158 filed on Jan. 22, 2016.

### STATEMENT REGARDING FEDERALLY SPONSORED RESEARCH AND DEVELOPMENT

Not Applicable.

### FIELD OF THE DISCLOSURE

The present embodiment relates generally to real-time virtual travel services, and more particularly to a system and method for enabling any internet user to access a real-time virtual travel demonstration of geographical locations without having to be physically present at those locations.

### DISCUSSION OF RELATED ART

Virtual tourism has seen explosive growth over the past several years. A virtual travelling system allows people to explore any geographical location without having to be physically present at those destinations. Virtual travelling systems provide a traveler with the capability of accessing a wide variety of interesting places where the stay could be extremely risky due to security reasons. Persons with limited mobility can also explore places of interest through the scope of virtual travelling. Virtual travelling sessions usually demonstrate geographical locations by means of pictures and videos.

Conventional virtual travel management systems utilize pre-recorded videos and images to demonstrate virtual travel sessions. In some conventional methods, the traveler can view the audio/video files by describing particular locations through the internet. However, these systems do not provide a method to observe the place from the point of view of the traveler. Such systems only provide an alternate view without the interaction of the traveler in real-time. In the current systems, there is no method to ensure the availability of a serviceman who operates the virtual travel demonstration according to the commands of a traveler. Further, the existing systems provide a communication between a traveler and a serviceman to demonstrate the real time picture and sound, however there is no option for automatic translation in traveler's preferred language. Such conventional systems do not include any payment processing methods for the virtual travel services. Moreover, the current virtual travel exploration options are not personalized thereby providing same content to all travelers regardless of their unique characteristics, interests and preferences. The existing systems fail to satisfactorily accommodate these competing requirements.

Therefore, there is a need for a virtual travel management system that provides a real-time demonstration of the geographical location according to real-time commands of the traveler. Such a needed system would introduce the capability of capturing and presenting updated geographical imagery with improved clarity. This system would provide a means to establish a real-time communication between the traveler and the serviceman in the traveler's preferred language. Further, this system would provide personalized virtual travel sessions based on the unique characteristics and preferences of the traveler. Such a needed system would possess a safe and cost effective payment processing method for the virtual travel services. Moreover, this needed system would provide a facility for a research group to arrange for the appropriate serviceman to meet a traveler's specific needs. The present embodiment accomplishes these objectives.

### SUMMARY OF THE DISCLOSURE

The present invention relates to a method and system to provide an on-demand real-time virtual travel service to a traveler. The present invention discusses in detail about the system and method enabling any internet traveler to access a real-time, virtual travel demonstration of geographical locations without having to be physically present at those destinations.

In the preferred embodiment, a virtual travel management system residing on a computer server having a processor coupled with a memory unit integrated with a central database provides the real-time virtual travel service to the traveler. The processor is installed with a virtual travel management software application. The virtual travel management system enables the communication of the traveler and at least one proxy utilizing a communication interface via a network. The at least one proxy is equipped with at least one portable audio-video monitoring and transmitting device and a proxy communication device. Similarly, the traveler is equipped with a multimedia receiving device and a traveler communication device. The at least one proxy and the traveler communicates with each other directly utilizing the proxy communication device and the traveler communication device respectively or through a communication interface. The traveler communication device includes but not limited by a smart phone, a laptop, a personal computer or a tablet computer. And the proxy communication device may be a regular cell phone or any portable communication device.

The proxy communication device and the traveler communication device are installed with the virtual travel management software application. The traveler and the proxy access the virtual travel management software application through a virtual travel management website. The at least one portable audio-video monitoring and transmitting device transmits specific virtual travel demonstrations of picture and sound from a proxy location to the multimedia receiving device in response to the traveler's commands. The multimedia receiving device receives and displays the real-time demonstration of picture and sound to the traveler. If the proxy's criteria is inconsistent with the traveler's expectations then a request goes to the processor to foresee all possible options for finding a proxy whose criteria is consistent with the traveler's real-time virtual travel service commands.

The method is initiated by enabling the at least one proxy to register and storing a plurality of personal data in the central database utilizing the proxy communication device through a proxy input interface at the processor via the network. The plurality of personal data includes, but not limited to location, places of interest where the proxy can come through, transmitting equipment, working languages, experience and special skills of the proxy. During registration, the system creates a plurality of service options for the proxy by sorting the plurality of personal data utilizing a multistate feature selection module at the processor. Thereafter, the at least one proxy receives a personal access code for accessing the virtual travel management system. The system allows the traveler to file a virtual travel service request utilizing the traveler communication device through a traveler input interface via the network. Upon filing the virtual travel service request, the virtual travel management system enables the traveler to compare the traveler's virtual travel service request with the plurality of service options for the proxy. In this comparison step, the traveler checks whether the proxy's possibilities are consistent with the traveler's expectations. A matching list of the plurality of service options for the proxy is created if the plurality of service options matches with the traveler's service request. If there is no match, the virtual travel service request will be sent to a research module at the processor and a request is sent to the processor to foresee all possible options for the plurality of service options for the at least one proxy. Next, the system facilitates the traveler to select at least one service option from the list of the plurality of service options for the at least one proxy. The preferred embodiment manages the payment method for the virtual travel service and presents a bill to the traveler for the at least one service option selected by the traveler. Upon making the payment, the virtual travel management system connects the traveler and the selected proxy through a communication interface at the processor via the network. Next, a communication is initiated between the traveler and the proxy in a preferred language of the traveler utilizing an automatic multi language translator module at the processor. Thereafter, the system allows the proxy to move through different locations according to the traveler's commands and starts the real-time demonstration of picture and sound utilizing the at least one portable audio-video monitoring and transmitting device. If the traveler desires to change the current location and likes to view new scene then the traveler sends real-time commands to the proxy to make the proxy to respond with real-time changes of demonstration of picture and sound from the proxy's new location. Further, the traveler can ask questions based on the real-time demonstrations to the proxy and the proxy answers to those quickly in the preferred language of the traveler. This real-time communication provides the traveler a feel that he/she is really traveling at those locations. Finally, the system transfers the payment made by the traveler for the virtual travel service to the at least one proxy after expiring the virtual travel service.

In accordance with another exemplary embodiment of the present invention, a non-transitory computer-readable medium comprises computer-executable instructions stored therein for causing a computer to implement a program executable on a virtual travel management system for providing a virtual travel demonstration of geographical locations to a traveler without having to be physically present at those locations.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a high level block diagram illustrating a system and method for providing a real time virtual travel service to a traveler utilizing a virtual travel management system;

FIG. 2 is a block diagram illustrating different components of the virtual travel management system shown in FIG. 1; and

FIGS. 3A and 3B illustrate a flowchart describing the method for providing the real-time virtual travel service to the traveler in accordance with an embodiment of the present invention.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

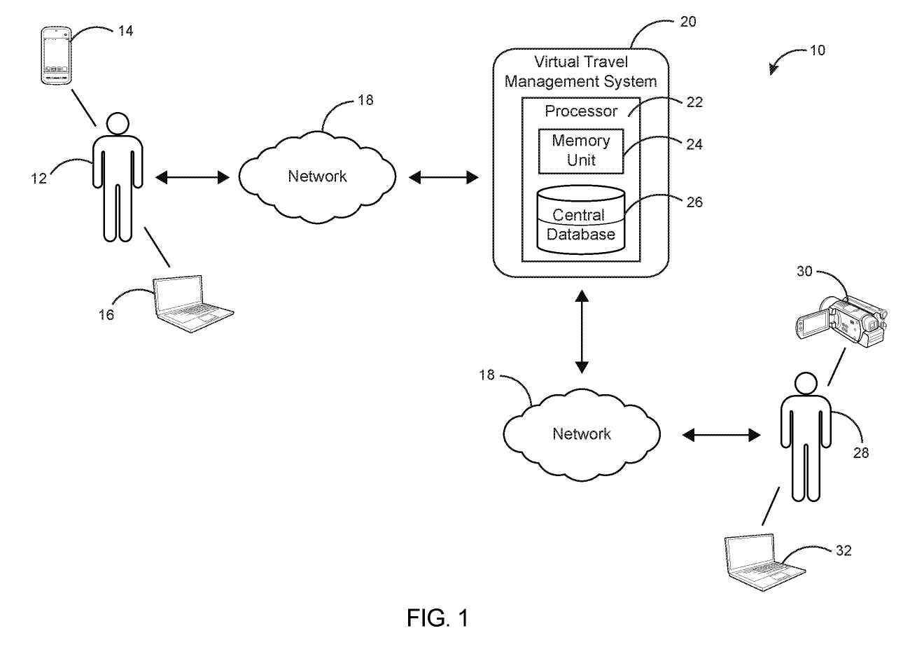

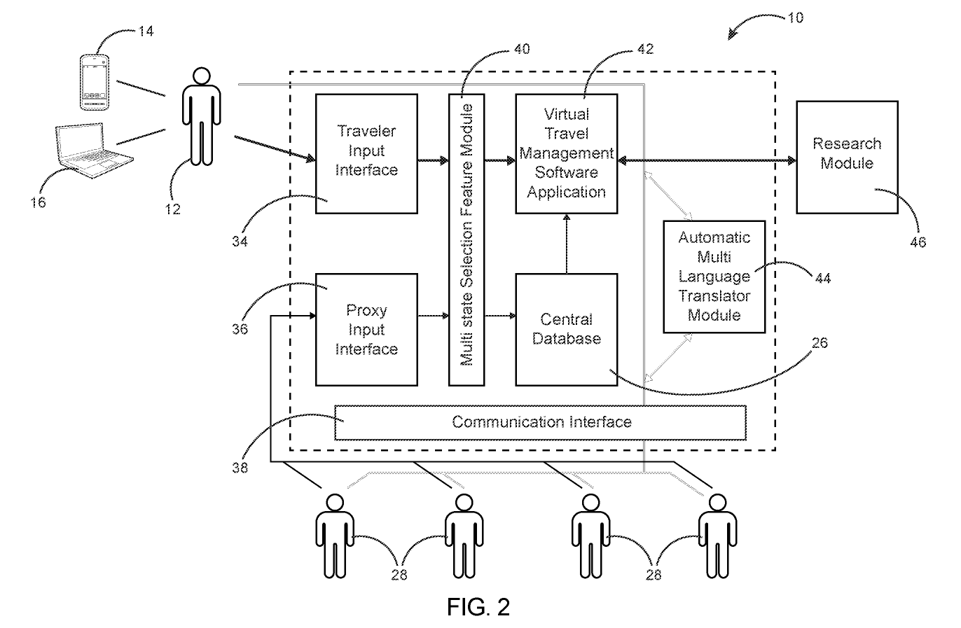

Turning first to FIG. 1, a high level block diagram of a virtual travel management system 10 for providing a real time virtual travel service to a traveler 12 is illustrated. The virtual travel management system 10 enables a communication between the traveler 12 and at least one proxy 28 utilizing a traveler communication device 14 and a proxy communication device 32 via a network 18. The at least one proxy 28 may be a serviceman or a machine. The virtual travel management system 10 facilitates the traveler 12 to explore any location without having to be physically present at those destinations. In the preferred embodiment, the virtual travel management system 10 includes a computer server 20 having a processor 22 installed with a virtual travel management software application 42 (See FIG. 2). The processor 22 is coupled with a memory unit 24 integrated with a central database 26. The traveler communication device 14 and the proxy communication device 32 are installed with the virtual travel management software application 42 for enabling the real time virtual travel service. The software application 42 (See FIG. 2) may be a mobile application, a desktop computer application, an embedded software program, or any other type of software application that runs on the processor 22 of the server 20. The traveler 12 and the proxy 28 access the virtual travel management software application through a virtual travel management website utilizing the traveler communication device 14 and the proxy communication device 32 respectively.

In order to avail the service of the virtual travel management system 10, the at least one proxy 28 and the traveler 12 should be a registered member in the virtual travel management system 10. The proxy 28 provides information regarding a plurality of personal data in the virtual travel management website utilizing the at least one proxy communication device 32. The plurality of personal data is stored in the central database 26 and is utilized by the proxy 28 to login to the virtual travel management website. The at least one proxy 28 and the traveler 12 communicate with each other directly utilizing the proxy communication device 32 and the traveler communication device 14 respectively or through a communication interface 38. The proxy communication device 32 may be a smart phone, a laptop, a personal computer or a tablet computer. And the traveler communication device 14 may be a regular cell phone or any portable communication device.

The proxy 28 is equipped with at least one portable audio-video monitoring and transmitting device 30 that provides specific virtual travel demonstrations from a proxy location according to the traveler's command and the traveler 12 is equipped with a multimedia receiving device 16. The at least one portable audio-video monitoring and transmitting device 30 is capable of capturing and presenting updated geographical imagery with improved clarity to the traveler 12. The at least one portable audio-video monitoring and transmitting device 30 includes but not limited by smart video camera, smart phone, laptop, Google Glass etc.

As shown in FIG. 2, the virtual travel management system 10 comprises a traveler input interface 34, a proxy input interface 36, a multistate selection feature module 40, a communication interface 38, the virtual travel management software application 42, the central database 26, an automatic multi language translator module 44 and a research module 46.

The proxy input interface 36 enables the proxy 28 to provide the plurality of personal data in the virtual travel management website according to the structure of the multistate selection feature module 40 for registering in the system 10. The plurality of personal data of the at least one proxy 28 includes proxy's location, places of interest, type of transmitting equipment, known languages, work experience and special skills of the at least one proxy 28. The traveler input interface 34 enables the traveler 12 to provide a plurality of traveler information to the virtual travel management website to file a virtual travel service request utilizing the traveler communication device 14.

The plurality of traveler information should be consistent with the structure of the multistate selection feature module 40. The communication interface 38 makes the communication between the traveler 12 and the proxy 28 alive. The multistate selection feature module 40 enables to sort the proxy's personal data and matches the traveler's virtual travel request with the at least one proxy 28. The automatic multi language translator module 40 facilitates the traveler-proxy communication in traveler preferred languages.

The traveler 12, who desires to make the real-time virtual travel to some location equipped with the traveler communication device 14 and at least one multimedia receiving device 16, enters the virtual travel management software application 42 for searching the at least one proxy 28, who are in this location and can provide him/her with specific services. The multimedia receiving device 16 of the traveler 12 includes but not limited by a laptop, a desktop computer and a television set. The traveler 12 and the proxy 28 interact with the virtual travel management system 10 through the traveler input interface 34 and the proxy input interface 36 respectively.

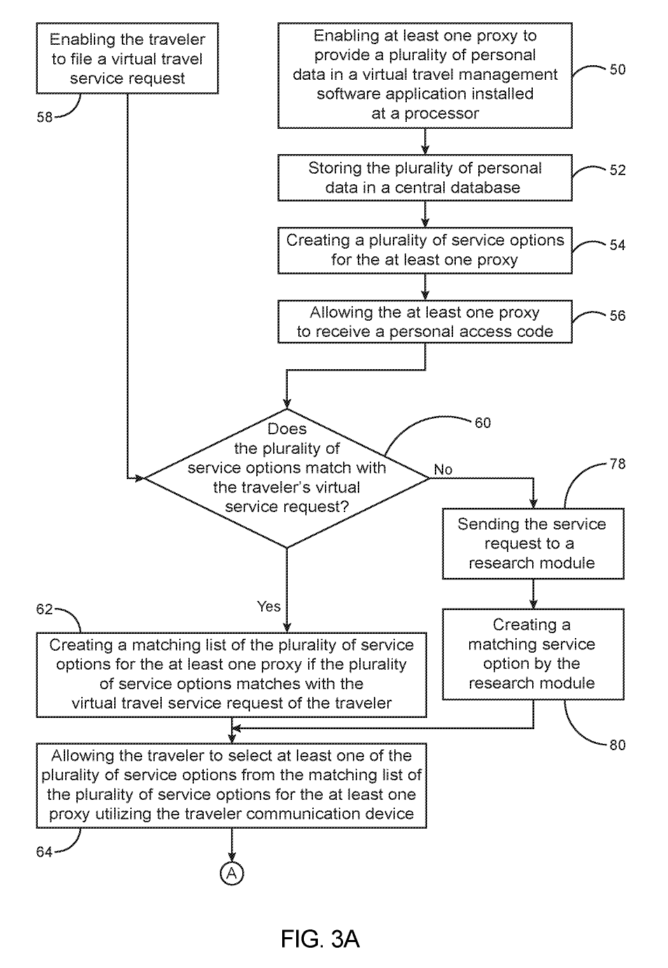

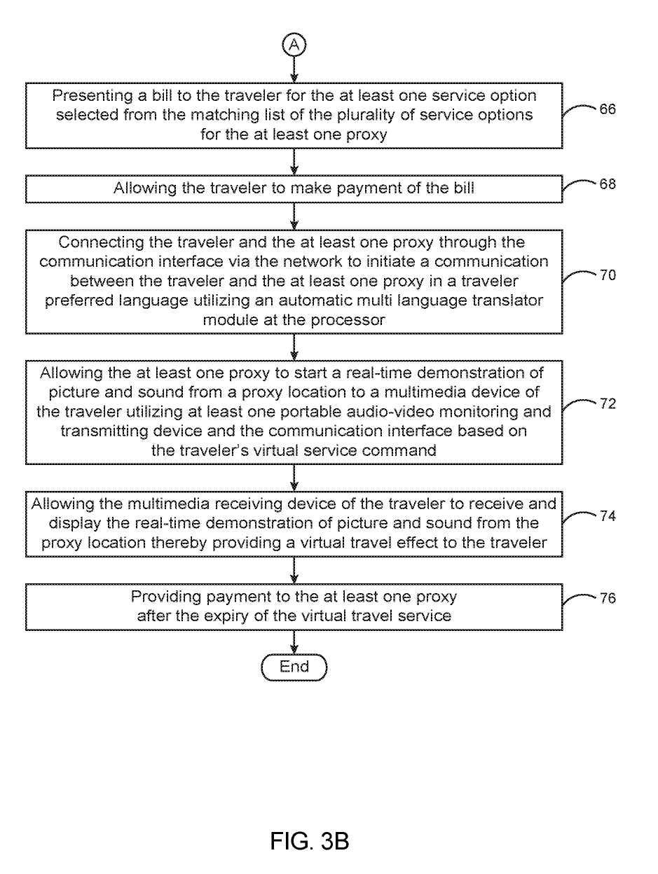

FIGS. 3A and 3B illustrate a flowchart describing the method for providing the real-time virtual travel service in accordance with an embodiment of the present invention. The preferred method commences by enabling the at least one proxy to provide the plurality of personal data in the virtual travel management website utilizing the proxy communication device through the proxy input interface via the network as indicated at block 50. The virtual travel management system allows several proxies to register in the virtual travel management website. The plurality of personal data of each proxy includes proxy's location, places of interest, type of transmitting equipment, known languages, work experience and special skills of the proxy. The central database stores the plurality of personal data provided by each proxy as shown in block 52. The processor creates a plurality of service options for each proxy by sorting the plurality of personal data according to the structure of the multistate selection feature module as shown in block 54. The virtual travel software application creates a personal access code for each proxy. Each proxy receives the personal access code through the proxy communication device and gains access to the communication interface as shown in block 56. Next, the traveler files a virtual travel service request by providing the plurality of traveler information to the virtual travel management website utilizing the traveler communication device through the traveler input interface as indicated at block 58. The plurality of traveler information includes but not limited to places of traveler's interest, travel time, duration, price and other specific conditions. The places of interest includes but not limited to cities, heritage object museums and mass events like mass praying and sport events.

As shown in block 60, the processor enables the traveler to compare the traveler's virtual travel service request with the plurality of service options for the proxies. If the plurality of service options matches with the traveler's virtual travel service request then the system creates a matching list of the plurality of service options for the proxies as indicated at block 62. And, if the plurality of service options of any of the proxies does not match with the traveler's virtual travel service request then the virtual travel service request of the traveler is automatically sent to the research module as indicated at block 78 and a request is sent to the processor to foresee all the possible options for the plurality of service options for the at least one proxy. The research module is designed to find a way to solve the problem and to create at least one appropriate matching service option as shown in block 80. Thereafter, the traveler selects at least one of the plurality of service options from the matching list of one of the proxies utilizing the traveler communication device as indicated at block 64. The preferred embodiment manages the payment method for the virtual travel service and a bill is presented to the traveler for the at least one service option selected from the matching list of the plurality of service options for the selected proxy as shown in block 66. Upon presenting the bill, the system allows the traveler to make the payment of the bill utilizing the traveler communication device as shown in block 68. Next, the traveler is connected to the proxy through the communication interface via the network to initiate a communication between the traveler and the proxy in traveler's preferred language utilizing the automatic multi language translator module as indicated at block 70. Thereafter, the proxy equipped with the at least one portable audio-video monitoring and transmitting device and the at least one portable communication device, moves through the traveler preferred location and transmits a real-time demonstration of picture and sound to the multimedia device of the traveler in response to the virtual travel service command of the traveler as indicated at block 72. Thereafter, the system enables the multimedia receiving device of the traveler to receive and display the real-time demonstration of picture and sound from the proxy location thereby providing the real-time virtual travel effect to the traveler as shown in block 74. At this moment, the traveler can ask questions regarding the real-time demonstrations and the proxy answers to those questions immediately. This real-time demonstration provides a real travel effect to the traveler. During the real-time demonstration, the traveler feels like he is actually travelling to those locations and talking to the proxy in real-life. Finally, the system transfers the payment made by the traveler for the virtual service to the at least one proxy after the expiry of the virtual travel service as shown in block 76.

In one embodiment, a non-transitory computer-readable medium comprises computer-executable instructions stored therein for causing a computer to implement a program executable on a virtual travel management system 10 for providing a virtual travel demonstration of geographical locations to a traveler 12 without having to be physically present at those locations. The non-transitory computer readable storage medium comprises a USB memory, CD-ROM, flexible disc, DVD or a flash memory. In one embodiment, a non-transitory computer-readable medium comprises computer-executable instructions stored therein for causing mobility solutions to implement a program executable on a virtual travel management system 10 that enables a proxy 28 to transmit real-time demonstration of picture and sound from a proxy location thereby providing a real-time virtual travel effect to the traveler 12.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A management system for providing travel service, the management system resides on a computer server having a processor coupled with a memory unit, the processor being configured to:
enable at least one proxy to provide a plurality of data in a management software application at the processor for registering in the management system utilizing a proxy communication device through a proxy input interface;
create a plurality of service options for the at least one proxy by sorting the plurality of data according to the structure of a multistate selection feature module at the processor;
enable the traveler to file a request by providing a plurality of traveler information to the management software application utilizing a traveler communication device installed with the management software application through a traveler input interface at the processor;
compare the request with the plurality of service options for the at least one proxy;
create a list of the plurality of service options for the at least one proxy if the plurality of service options matches with the request of the traveler;
send the request of the traveler to a research module at the processor if the plurality of service options does not match with the traveler's request;
allow the traveler to select at least one of the plurality of service options from the list of the plurality of service options for the at least one proxy utilizing the traveler communication device;
connect the traveler and the at least one proxy through the communication interface via the network to initiate a communication between the traveler and the at least one proxy in a traveler's preferred language utilizing an automatic multi language translator module at the processor; and
allow the at least one proxy to transmit a real-time demonstration of picture and sound from a proxy location to a multimedia receiving device of the traveler.

2. The management system of claim 1 wherein the proxy communication device and the traveler communication device are portable communication devices including but not limited by a smart phone, a laptop, a personal computer and a tablet computer.

3. The management system of claim 1 wherein the at least one portable audio-video monitoring and transmitting device of the at least one proxy includes but not limited to a smart video camera, a smart phone, a laptop and Google Glass.

4. The management system of claim 1 wherein the plurality of data of the at least one proxy includes but not limited by geographic location of the proxy, places of interest, type of transmitting equipment, working languages, work experience and special skills of the at least one proxy.

5. The management system of claim 1 wherein the at least one proxy is a serviceman.

6. The management system of claim 1 wherein the at least one proxy is a machine.

7. The management system of claim 1 wherein the plurality of traveler information is consistent with the structure of the multistate selection feature module.

8. The management system of claim 1 wherein the multimedia receiving device of the traveler is selected from a group consisting of a laptop, a desktop computer and a television set.

9. A method for providing a real-time virtual travel service to a traveler utilizing a management system residing on a computer server having a processor coupled with a memory unit integrated with a central database, the method comprising the steps of::
a) enabling at least one proxy to provide a plurality of data in a virtual travel management software application installed at the processor for registering in the virtual management system utilizing a proxy communication device through a proxy input interface;
b) creating a plurality of service options for the at least one proxy by sorting the plurality of data according to the structure of a multistate selection feature module at the processor;
c) allowing the at least one proxy to receive a access code to gain access to a communication interface at the processor;
d) enabling the traveler to file a virtual travel service request by providing a plurality of traveler information to the virtual travel management software application utilizing a traveler communication device installed with the virtual travel management software application through a traveler input interface at the processor;
e) comparing the virtual travel service request with the plurality of service options for the at least one proxy;
f) creating a list of the plurality of service options for the at least one proxy if the plurality of service options matches with the virtual travel service request of the traveler;
g) allowing the traveler to select at least one of the plurality of service options from the list of the plurality of service options for the at least one proxy utilizing the traveler communication device;
h) allowing the traveler to make payment of the bill utilizing the traveler communication device;
i) connecting the traveler and the at least one proxy through the communication interface to initiate a communication between the traveler and the at least one proxy in a traveler's preferred language utilizing an automatic multi language translator module at the processor; and
j) allowing the at least one proxy to transmit a real-time demonstration of picture and sound from a proxy location to a multimedia receiving device of the traveler utilizing at least one portable audio-video monitoring and transmitting device and the communication interface in response to the traveler's virtual travel service real-time commands.

10. The method of claim 9 wherein the at least one proxy is a serviceman.

11. The method of claim 9 wherein the at least one proxy is a machine.

12. The method of claim 9 wherein the processor sends the traveler's virtual travel service request to a research module at the processor if the plurality of service options does not match with the virtual travel service request of the traveler.

13. The method of claim 9 wherein the proxy communication device and the traveler communication device includes but not limited to a smart phone, a laptop, a personal computer and a tablet computer.

14. The method of claim 9 wherein the at least one portable audio-video monitoring and transmitting device of the at least one proxy includes but not limited to a smart video camera, a smart phone, a laptop and Google Glass.

15. The method of claim 9 wherein the plurality of data of the at least one proxy includes but not limited to geographic location, places of interest, type of transmitting equipment, working languages, experience and special skills of the at least one proxy.

16. The method of claim 9 wherein the multimedia receiving device of the traveler includes but not limited to a laptop, a desktop computer and a television set.

17. A non-transitory computer-readable medium having computer-readable program code embodied therein which when executed by a computer causes the computer to perform the following steps:
a) enabling at least one proxy to provide a plurality of data in a virtual travel management software application installed at a processor in the computer for registering in a virtual management system utilizing a proxy communication device through a proxy input interface;
b) storing the plurality of personal data in a central database integrated
c) with the processor;
d) creating a plurality of service options for the at least one proxy by sorting the plurality of data according to the structure of a multistate selection feature module at the processor;
e) allow the at least one proxy to receive a access code to gain access to a communication interface at the processor;
f) enabling the traveler to file a virtual travel service request by providing a plurality of traveler information to the virtual travel management software application utilizing a traveler communication device installed with the virtual travel management software application through a traveler input interface at the processor;
g) comparing the virtual travel service request with the plurality of service options for the at least one proxy;
h) creating a matching list of the plurality of service options for the at least one proxy if the plurality of service options matches with the virtual travel service request of the traveler;
i) allowing the traveler to select at least one of the plurality of service options from the matching list of the plurality of service options for the at least one proxy utilizing the traveler communication device;
j) presenting a bill to the traveler for the at least one service option selected from the matching list of the plurality of service options for the at least one proxy;
k) allowing the traveler to make payment of the bill utilizing the traveler communication device;
l) connecting the traveler and the at least one proxy through the communication interface to initiate a communication between the traveler and the at least one proxy in a traveler's preferred language utilizing an automatic multi language translator module at the processor;
m) allowing the at least one proxy to start a real-time demonstration of picture and sound from a proxy location to a multimedia receiving device of the traveler utilizing at least one portable audio-video monitoring and transmitting device and the communication interface in response to the traveler's virtual travel service real-time commands;
n) allowing the multimedia receiving device of the traveler to receive and display the real-time demonstration of picture and sound from the proxy location thereby providing a virtual travel effect to the traveler; and
o) providing payment to the at least one proxy after the expiry of the virtual travel service;
whereby the virtual travel management software application, the multimedia receiving device and the at least one portable audio-video monitoring and transmitting device provide on-demand real-time virtual travel effect to the traveler.

18. The non-transitory computer-readable medium of claim 17 wherein the processor sends the traveler's virtual travel service request to a research module at the processor if the plurality of service options does not match with the traveler's virtual travel service request.

19. The non-transitory computer-readable medium of claim 17 wherein the plurality of traveler information provided by the traveler is consistent with the structure of the multistate selection feature module.
